(19) United States
(12) Patent Application Publication
(10) Pub. No.: US 2022/0187803 A1
(43) Pub. Date: Jun. 16, 2022

(54) Shop Floor Social Distancing for Aircraft Assembly

(71) Applicant: The Boeing Company, Chicago, IL (US)

(72) Inventors: Christopher J. Senesac, Daniel Island, SC (US); Michael Patrick Sciarra, Seattle, WA (US); Benjamin R. Naylor, North Charleston, SC (US)

(21) Appl. No.: 17/452,182

(22) Filed: Oct. 25, 2021

Related U.S. Application Data
(60) Provisional application No. 63/126,464, filed on Dec. 16, 2020.

(51) Int. Cl. G05B 19/418

(52) U.S. Cl. CPC G05B 19/4188; G05B 19/41865; G05B 19/41885

(57) ABSTRACT

A method, apparatus, system, and a computer program product for managing a manufacturing of an object. Work orders for the object that have work areas with less than a minimum safety distance from each other are identified by a computer system. A set of actions is performed by the computer system for the work orders to manage the manufacturing of the object.

### RELATED PROVISIONAL APPLICATION

This application is related to and claims the benefit of priority of provisional U.S. Patent Application Ser. No. 63/126,464, entitled “Shop Floor Social Distancing for Aircraft Assembly”, filed on Dec. 16, 2020, which is hereby incorporated by reference.

### BACKGROUND INFORMATION

### 1. Field

The present disclosure relates generally to a manufacturing system and, in particular, to a method, apparatus, system, and computer program product for scheduling social distancing on a shop floor for aircraft assembly.

### 2. Background

The assembly of an aircraft is an extremely complex process. Hundreds of thousands of parts may be assembled for an aircraft.

The assembly of an aircraft may involve manufacturing different parts of the aircraft in geographically diverse locations. These different parts may then be finally assembled in a single location. For example, different portions of a fuselage of a composite aircraft may be assembled in different locations and flown to a central location where the final assembly line is located. Additionally, other parts such as engines, auxiliary power units, seats, computer systems, line replaceable units, or other components in the aircraft may be shipped to this final location for assembly to form the assembled aircraft.

The assembly of the different parts involves assigning tasks to different operators. The assignment of these tasks may take the form of work orders. Each work order may include instructions and an identification of parts for a particular assembly in the aircraft. In performing tasks for the work orders, operators also take into account different environmental considerations. These environmental considerations can include accessibility to the area for performing a work order, safety factors, and other considerations. For example, an operator may not have an idea of what parts may or may not have already been installed in an aircraft for performing a particular task in a work order. Taking into account these considerations can take more time than desired.

Therefore, it would be desirable to have a method and apparatus that take into account at least some of the issues discussed above, as well as other possible issues. For example, it would be desirable to have a method and apparatus that overcome a technical problem with taking into account environmental considerations when performing tasks for work orders to assemble an aircraft.

### SUMMARY

An embodiment of the present disclosure provides a work management system comprising a computer system and a work manager in the computer system. The work manager is configured to identify work orders for an aircraft that have work areas with less than a minimum safety distance from each other in which the work orders are scheduled to be performed at times that overlap each other. The work manager is configured to perform a set of actions for the work orders.

Another embodiment of the present disclosure provides a work management system comprising a computer system and a work manager in the computer system. The work manager is configured to identify work orders for an object that have work areas with less than a minimum safety distance from each other. The work manager is configured to perform a set of actions for the work orders.

Yet another embodiment of the present disclosure provides a method for managing a manufacturing of an object. Work orders for the object that have work areas with less than a minimum safety distance from each other are identified by a computer system. A set of actions is performed by the computer system for the work orders to manage the manufacturing of the object.

Still another embodiment of the present disclosure provides a computer program product for managing a manufacturing of an object. The computer program product comprises a computer-readable storage media with first program code and second program code stored on the computer-readable storage media. The first program code is executable by a computer system to cause the computer system to identify work orders for the object that have work areas with less than a minimum safety distance from each other. The second program code is executable by the computer system to cause the computer system to perform a set of actions for the work orders to manage the manufacturing of the object.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a work order management environment in accordance with an illustrative embodiment;

FIG. 3 is an illustration of components in a work manager in accordance with an illustrative embodiment;

FIG. 4 is an illustration of a display of parts for work orders in a graphical user interface in accordance with an illustrative embodiment;

FIG. 5 is another illustration of a display of parts for work orders in a graphical user interface in accordance with an illustrative embodiment;

FIG. 6 is yet another illustration of a display of parts for work orders in a graphical user interface in accordance with an illustrative embodiment;

FIG. 7 is still another illustration of a display of parts for work orders in a graphical user interface in accordance with an illustrative embodiment;

FIG. 8 is an illustration of a flowchart of a process for managing a manufacturing of an object in accordance with an illustrative embodiment;

FIG. 9 is an illustration of a flowchart of a process for identifying work orders in accordance with an illustrative embodiment;

FIG. 10 is an illustration of a flowchart of a process for identifying work orders in accordance with an illustrative embodiment;

FIG. 11 is an illustration of a flowchart of a process for identifying work orders in accordance with an illustrative embodiment;

FIG. 12 is an illustration of a flowchart of a process for identifying a minimum safety distance for a work order in accordance with an illustrative embodiment;

FIG. 13 is an illustration of a flowchart of a process for managing a manufacturing of an object in accordance with an illustrative embodiment;

FIG. 14 is an illustration of a flowchart of a process for visualizing work orders for manufacturing an object in accordance with an illustrative embodiment;

FIG. 15 is an illustration of a flowchart of an operation for visualizing work orders for manufacturing an object in accordance with an illustrative embodiment;

FIG. 16 is another illustration of a flowchart of an operation for visualizing work orders for manufacturing an object in accordance with an illustrative embodiment;

FIG. 17 is yet another illustration of a flowchart of an operation for visualizing work orders for manufacturing an object in accordance with an illustrative embodiment;

FIG. 18 is an illustration of a block diagram of a data processing system in accordance with an illustrative embodiment;

FIG. 19 is an illustration of an aircraft manufacturing and service method in accordance with an illustrative embodiment;

FIG. 20 is an illustration of a block diagram of an aircraft in which an illustrative embodiment may be implemented; and

FIG. 21 is an illustration of a block diagram of a product management system in accordance with an illustrative embodiment.

### DETAILED DESCRIPTION

The illustrative embodiments recognize and take into account one or more different considerations. For example, the illustrative embodiments recognize and take into account that environmental conditions may be relevant to ensure that policies, regulations, and other considerations regarding safety can be met when performing tasks for work orders. For example, the illustrative embodiments recognize and take into account that minimum safety distances may be required between human operators performing work orders. For example, a minimum safety distance may be required for safety considerations such as infectious diseases, flammable materials, or other considerations.

The illustrative embodiments recognize and take into account that it is difficult to determine from reviewing work orders whether minimum safety distances can be met between the work orders that may be performed by human operators at the same time. The illustrative embodiments recognize and take into account that it would be desirable to enable human operators to perform tasks for work orders to assemble an aircraft in a manner that meets safety considerations.

Thus, the illustrative embodiments provide a method, apparatus, system, and computer program product for manufacturing a platform such as an aircraft. In the illustrative examples, work orders are identified for an aircraft that has work areas with less than a minimum safety distance from each other. A set of actions for the work orders can be performed based on this identification. For example, the work orders can be scheduled or rescheduled to meet design minimum safety distances.

As used herein, a “set of,” when used with reference to items, means one or more items. For example, a “set of actions” is one or more actions.

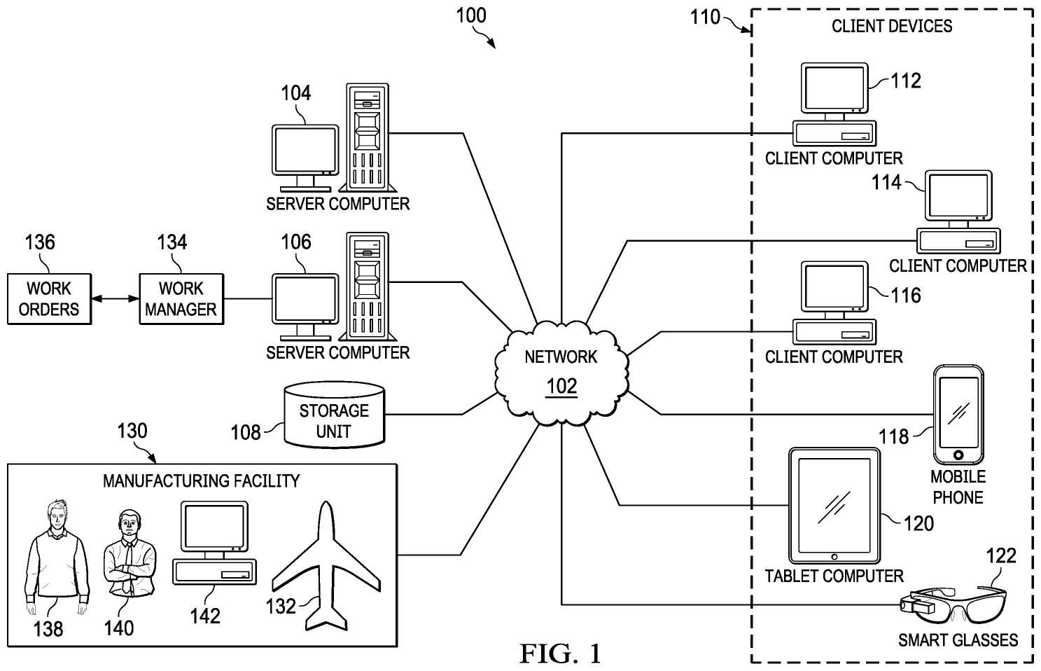

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet-of-things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, manufacturing facility 130 is a location in which aircraft 132 can be assembled. In this illustrative example, the assembly of an object such as aircraft 132 in manufacturing facility 130 can be managed by work manager 134 running in server computer 106.

As depicted, work manager 134 can assign work orders 136 to human operators, such as human operator 138 and human operator 140, to perform tasks in assembling aircraft 132 in manufacturing facility 130.

In this illustrative example, work manager 134 is configured to operate in a manner that can solve the complicated situation in scheduling the assembly of aircraft 132 on the shop floor of manufacturing facility 130 in a manner that meets safety considerations.

For example, work manager 134 can identify work orders 136 for aircraft 132 that have work areas with less than a minimum safety distance from each other. In this illustrative example, work orders 136 can include at least one of scheduled work orders or unscheduled work orders. When work orders are to be performed in work areas with less than a minimum safety distance, a set of actions can be performed for the work orders.

For example, in performing the set of actions, work manager 134 can display visualizations of work orders 136 on manufacturing computer 142 in manufacturing facility 130 to at least one of human operator 138 or human operator 140.

In this depicted example, the visualization can provide a view of the locations for performing work orders 136 inside or outside of aircraft 132 in assembling aircraft 132. This visualization of the locations can include indications of distancing present between different work orders.

These indications can indicate whether desired minimum safety distances are present to meet at least one of a policy, a manufacturing regulation, a government regulation, a work order instruction, or some other source describing minimum safety distances for performing tasks for work orders 136. With this visualization, a determination can be made as to whether the minimum safety distances are present between work orders 136.

These work orders can be already scheduled work orders or unscheduled work orders. With unscheduled work orders to be scheduled, a determination can be made as to when work orders are scheduled in order to avoid the work orders being performed with less than a minimum safety distance.

In this example, scheduled work orders that overlap during times when the work orders are to be performed and do not meet minimum safety distances can be rescheduled in a manner such that the minimum safety distances can be met in performing tasks for work orders 136.

Two visualizations can enable a human operator to schedule or reschedule work orders 136. In other illustrative examples, work orders 136 can be automatically rescheduled by work manager 134 in performing a set of actions.

The illustration of components for assembling aircraft 132 is presented for purposes of illustrating one implementation in which work orders 136 can be managed. The location and components are not meant to limit the manner in which other illustrative examples can be implemented. For example, work manager 134 can be located in a computer in manufacturing facility 130. In yet other illustrative examples, work manager 134 can be distributed among multiple data processing systems such as server computer 106, client computer 116, and smart glasses 122.

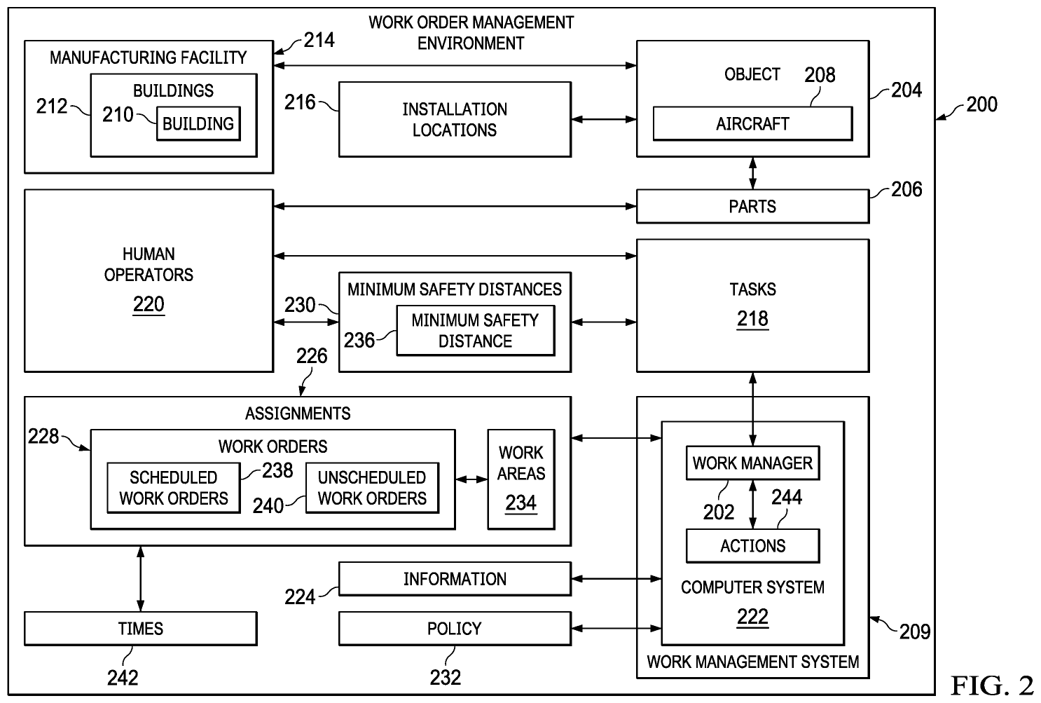

With reference now to FIG. 2, a block diagram of a work order management environment is depicted in accordance with an illustrative embodiment. In this illustrative example, work order management environment 200 includes components that can be implemented in hardware such as the hardware shown in network data processing system 100 in FIG. 1.

In the illustrative examples, work manager 202 can be used to manage the assembly of object 204 from parts 206. When object 204 is aircraft 208, work manager 202 may be a part of work management system 209.

A part in parts 206 is a group of components. As used herein, a “group of,” when used with reference items, means one or more items. For example, a “group of components” is one or more components. A part may be a single component or an assembly of components in these depicted examples. For example, the part may be a fastener, a strut, a seat, a row of seats, an in-flight entertainment system, a duct, a system of ducts, a global positioning system receiver, an engine, an engine housing, an inlet, or other suitable types of parts.

In this illustrative example, assembling of parts 206 can take place in building 210 in buildings 212 at manufacturing facility 214. The assembly of parts 206 for object 204 can occur in building 210. For example, the assembly of parts 206 in building 210 can occur at installation locations 216 relative to object 204 inside of building 210.

Each installation location in installation locations 216 can be inside of object 204 or outside of object 204. An installation location in installation locations 216 is where a group of tasks 218 is performed to assemble object 204.

In these illustrative examples, a task in tasks 218 is a piece of work. A task may be comprised of one or more operations that are performed by a group of human operators 220 assigned to work on the assembly of object 204.

As depicted, work manager 202 is located in computer system 222 and can be implemented in software, hardware, firmware, or a combination thereof. When software is used, the operations performed by work manager 202 can be implemented in program code configured to run on hardware, such as a processor unit. When firmware is used, the operations performed by work manager 202 can be implemented in program code and data and stored in persistent memory to run on a processor unit. When hardware is employed, the hardware can include circuits that operate to perform the operations in work manager 202.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 222 is a physical hardware system and includes one or more data processing systems. When more than one data processing system is present in computer system 222, those data processing systems are in communication with each other using a communications medium. The communications medium can be a network. The data processing systems can be selected from at least one of a computer, a server computer, a tablet computer, or some other suitable data processing system.

Computer system 222 can be located in the same location or in different geographic locations. For example, computer system 222 may be distributed through buildings 212 or located in building 210 in manufacturing facility 214. Portions of computer system 222 may be located in another geographic location separate from manufacturing facility 214. In managing the assembly of object 204, work manager 202 can manage tasks 218 and information 224 about object 204.

In the illustrative example, the management of tasks 218 may include at least one of assigning tasks 218 to human operators 220, monitoring statuses of tasks 218, organizing tasks 218, providing information about tasks 218, or other suitable operations. Information 224 can include, for example, models of objects, part inventories, safety policies, regulations, or other suitable information relating to manufacturing of object 204.

In these illustrative examples, work manager 202 can manage tasks 218 using assignments 226 in the form of work orders 228. For example, work manager 202 can assign tasks 218 to human operators 220 for performance and assembling of object 204 using work orders 228. Each work order in work orders 228 can include one or more of tasks 218. For example, a work order can comprise a group of tasks 218 that is performed in a group of installation locations 216.

In this illustrative example, object 204 may be in different states of assembly. Tasks 218 are placed into work orders 228 with a logical progression for assembling object 204 based on the current state of assembly of object 204.

In this illustrative example, the performance of tasks 218 in work orders 228 can be subject to minimum safety distances 230 set by policy 232. Policy 232 is one or more rules and may include information used to apply those rules. For example, minimum safety distances 230 can be based on at least one of a social distancing policy, a health safety policy, flammability, a stay-out zone, a welding safety distance, or some other rule used to determine minimum safety distances 230 using policy 232.

In the illustrative example, installation locations 216 for work orders 228 can affect the scheduling of work orders 228 when taking into account policy 232. For example, work manager 202 can identify work orders 228 for object 204 that have work areas 234 with less than minimum safety distance 236 from each other. In this illustrative example, minimum safety distances 230 for work orders 228 are intended to maintain the desired amount of distance between human operators 220 from each other when working on different work orders.

For example, when a first human operator performs tasks for a first work order and a second human operator performs tasks for a second work order, minimum safety distance 236 should be present between the work areas for those two work orders. In this manner, the minimum safety distance can also be maintained between the first human operator and the second human operator assigned to the work orders.

This identification of work orders 228 can be performed for at least one of scheduled work orders 238 or unscheduled work orders 240 in work orders 228.

For example, with scheduled work orders 238, work manager 202 can identify scheduled work orders 238 in work orders 228 for object 204 that have work areas 234 with less than minimum safety distance 236 from each other in which work orders 228 are scheduled to be performed at times 242 that overlap each other. In other words, this identification can be made for all of work orders 228 that have been scheduled to be performed.

In this illustrative example, the scheduling may not include assignments of work orders 228 to human operators 220. In other words, the scheduling may only be selecting a time or times when work orders 228 are to be performed.

In this illustrative example, a time in times 242 is a period of time during which a set of tasks 218 in a work order is to be performed. The time can be the actual amount of time that it should take to perform tasks 218 in the work order. The time can also be a day or some time period during which the work order is expected to be performed and completed. In other words, the time can be longer than the time needed to actually perform tasks 218 in the work order.

As depicted, a work area in work areas 234 for a work order in work orders 228 is the area in which parts 206 used in a work order are located when the parts are installed for the work order. In some examples, the work order may only include a single part. The work area can also include the space needed for the human operator performing the installation.

In this illustrative example, the work area is a three-dimensional volume. In another illustrative example, the work area can be a two-dimensional area.

In other words, the work area can include where the human operator is located when installing one or more parts for the work order. In this illustrative example, the work area for a work order can also take into account a structure or structures that separates one work area from another work area in work areas 234. For example, if a wall or a floor separates two work areas, then minimum safety distance 236 may be reduced.

In another illustrative example, when unscheduled work orders 240 are present, work manager 202 can identify unscheduled work orders 240 in work orders 228 for object 204 that have work areas 234 with less than minimum safety distance 236 from each other. In other words, the identification made by work manager 202 can be made for all of work orders 228 that have not been scheduled. Further, the determination can be made for all of work orders 228 regardless of whether work orders 228 have been scheduled.

In yet another illustrative example, work manager 202 can identify work orders 228 for object 204 that have work areas 234 with less than minimum safety distance 236 from each other in which work orders 228 are scheduled to be performed at times 242 that overlap each other and in which different human operators in human operators 220 are assigned to work orders 228 that have work areas 234 with less than minimum safety distance 236 from each other. This type of modification can be used to examine operations that have already been assigned for performance to particular human operators.

In this manner, work manager 202 can identify work orders 228 to be performed at times 242 that overlap each other with work areas 234 that do not have minimum safety distance 236 and are assigned to different human operators. This type of identification can avoid reassigning scheduled work orders 238 in work orders 228 with the same human operator that do not have minimum safety distance 236.

In this illustrative example, work manager 202 can perform a set of actions 244 for work orders 228 that have been identified as having work areas 234 less than minimum safety distance 236 from each other.

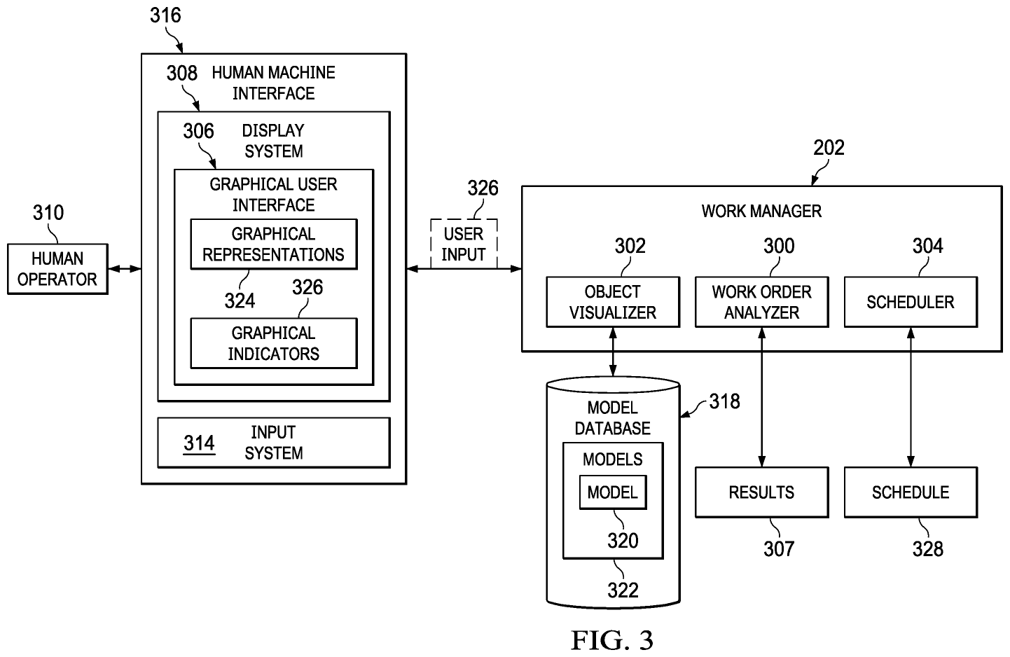

Turning next to FIG. 3, an illustration of components in a work manager is depicted in accordance with an illustrative embodiment. In the illustrative examples, the same reference numeral may be used in more than one figure. This reuse of a reference numeral in different figures represents the same element in the different figures.

In this illustrative example, work manager 202 comprises work order analyzer 300, object visualizer 302, and scheduler 304. These components are examples of some components that may be implemented in work manager 202 and are not intended to limit components that can be implemented in addition to or in place of these components to perform a set of actions 244.

As depicted, work order analyzer 300 is configured to identify work areas for some or all of work orders 228. Further, work order analyzer 300 is also configured to determine minimum safety distance 236 between work areas 234 for work orders 228. This type of analysis can be performed on at least one of scheduled work orders 238 or unscheduled work orders 240 in work orders 228.

This determination of minimum safety distance 236 can be made using policy 232 which may define minimum safety distance 236. Minimum safety distance 236 may change from work order to work order depending on a particular task in tasks 218 that is to be performed for a work order.

For example, minimum safety distance 236 may be determined to be six feet based on a social distancing rule by a government agency such as the Centers for Disease Control and Prevention (CDC). If a task includes a stay-out zone that is greater than six feet, then minimum safety distance 236 can be set to be the distance defined by the stay-out zone.

Further, the type of personal protection equipment (PPE) used for a task may also reduce minimum safety distance 236. For example, less than six feet may be required if a task in a work order is a paint application task in which a human operator wears a respirator.

Additionally, work order analyzer 300 can also take into account structures in object 204. Structures such as an interior wall, a bulkhead, a floor, a fuselage, or other structures can affect minimum safety distance 236. For example, if one work order is performed on one side of a wall while another work order is performed on the other side of the wall, the work areas may be separated by the thickness of the wall. In this example, if a social distancing rule is applied in policy 232, minimum safety distance 236 may not need to be six feet because of the presence of the wall between the two work areas.

Work order analyzer 300 generates results 307 that identify at least one of work orders 228 that have work areas 234 less than minimum safety distance 236 or work orders 228 with at least minimum safety distance 236 being present between work areas 234 for work orders 228. In this illustrative example, results 307 can also identify whether a work order has been scheduled for performance, scheduling information, parts for installation, instructions, other information relating to work order 228. In this illustrative example, results 307 can be used by at least one of object visualizer 302 or scheduler 304 to perform a set of actions 244.

In this illustrative example, object visualizer 302 is configured to display a visualization of information in graphical user interface 306 in display system 308. In this illustrative example, display system 308 is a physical hardware system and includes one or more display devices on which graphical user interface 306 can be displayed to human operator 310. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

Human operator 310 is a person that can interact with graphical user interface 306 through user input 312 generated by input system 314. Input system 314 is a physical hardware system and can be selected from at least one of a mouse, a keyboard, a trackball, a touchscreen, a stylus, a motion sensing input device, a gesture detection device, a cyber glove, or some other suitable type of input device. Display system 308 and input system 314 form human machine interface (HMI) 316.

In this illustrative example, object visualizer 302 is configured to access model database 318 to identify model 320 from models 322. Models 322 can take different forms. For example, without limitation, models 322 can include computer-aided design (CAD) files.

In this illustrative example, model 320 is a model of object 204 in the form of aircraft 208. Model 320 can be used to generate graphical representations 324.

Graphical representations 324 can be generated for parts 206 that are assembled to form work orders 228 in FIG. 2. Graphical representations 324 can also be generated for a set of sections in aircraft 208 in FIG. 2. The set of sections can be one or more sections in which installation locations 216 in FIG. 2 for work orders 228 are present. Work orders 228 can be determined from results 307, and work orders 228 identified for display may be a portion or all of work orders 228 depending on results 307 generated by work order analyzer 300 analyzing work orders 228 with respect to minimum safety distance 236 for work areas 234.

The generation of graphical representations 324 by object visualizer 302 may be based on all of model 320 or a group of volumes in model 320. These volumes may have different shapes. For example, the volumes can be selected from a cube, a cuboid, a cylinder, a sphere, or some other suitable shape. These volumes can encompass sections or portions of aircraft 208.

Further, based on results 307 generated by work order analyzer 300, object visualizer 302 can display a set of graphical indicators 326. In this illustrative example, the set of graphical indicators 326 is displayed in association with one or more of graphical representations 324.

In these illustrative examples, a graphical indicator in graphical indicators 326 is considered to be displayed in association with a graphical representation in graphical representations 324 when the attention of an operator viewing graphical indicators 326 is drawn to the parts. Thus, the graphical indicator may be displayed as part of the graphical representation, on the graphical representation, in some proximity of the graphical representation, or in some other suitable manner that draws attention to the graphical representation.

The set of graphical indicators 326 displayed in association with graphical representations 324 of parts 206 may take different forms. For example, the set of graphical indicators 326 may be selected from at least one of a color, a cross-hatching, an icon, a high lighting, an animation, or other suitable types of graphical indicators.

In the depicted example, the set of graphical indicators 326 can include a graphical indicator outlining a work area. This outline can be two or three-dimensional. In another example, the set of graphical indicators 326 can indicate minimum safety distance 236. In yet another illustrative example, the set of graphical indicators 326 can also indicate whether minimum safety distance 236 between two of work orders 228 has been met.

In this manner, a visualization of work orders 228 in results 307 can be displayed in graphical user interface 306 to human operator 310. This visualization can show information such as at least one of parts 206, work orders 228, work areas 234, minimum safety distances 230, or other information. As another example, the set of graphical indicators 326 may indicate when particular work orders that have already been scheduled should be rescheduled.

In this illustrative example, scheduler 304 is configured to schedule work orders 228. For example, scheduler 304 can assign human operators 220 and times 242 for work orders 228 to generate schedule 328. In this illustrative example, schedule 328 contains all of work orders 228 that have been assigned for performance. Work orders 228 in schedule 328 can be distributed to human operators for performance in these illustrative examples.

As depicted, scheduler 304 can schedule work orders 228 automatically using at least one of a policy, an artificial intelligence system, a machine learning model, or some other suitable process. In other illustrative examples, scheduler 304 can receive user input 312 from human operator 310 to generate schedule 328. In yet other illustrative examples, schedule 328 can be generated based on a combination of assignments performed by scheduler 304 and user input 312 received from human operator 310.

In this illustrative example, human operator 310 may schedule or reschedule work orders 228 using a visualization of work orders 228 displayed in graphical representations 324 and information displayed by graphical indicators 326. Graphical indicators 326 may provide human operator 310 an indication of when minimum safety distance 236 is not present between work areas 234 for two work orders. In this case, human operator 310 can assign the work orders to the same human operator if possible. Alternatively, human operator 310 can assign different times 242 to these two work orders such that times 242 do not overlap.

As another example, adjustments to minimum safety distance 236 as initially determined by work order analyzer 300 can be made based on including personal protection equipment (PPE) requirements in two work orders for which minimum safety distance 236 is not met.

In one illustrative example, one or more technical solutions are present that overcome a technical problem with taking into account environmental considerations when performing tasks for work orders to assemble an object such as an aircraft. As a result, one or more technical solutions can provide a technical effect in which work orders 228 are identified for which minimum safety distance 236 between work areas 234 is not met. With this identification, scheduling can be made or changed such that times 242 at which those work orders are to be performed do not overlap.

In another illustrative example, assignment of those two work orders to the same human operator can be made as another potential action. In another illustrative example, the addition or changing of personal protection equipment requirements can be made in order to change minimum safety distance 236 such that minimum safety distance 236 is met between work areas 234 for work orders 228. This information can be used to manage the manufacturing of object 204 such as aircraft 208 in a manner that meets safety requirements that involve minimum safety distances.

Computer system 222 can be configured to perform at least one of the steps, operations, or actions described in the different illustrative examples using software, hardware, firmware, or a combination thereof. As a result, computer system 222 operates as a special purpose computer system in which work manager 202 in computer system 222 enables managing the manufacturing of object 204. In particular, work manager 202 transforms computer system 222 into a special purpose computer system as compared to currently available general computer systems that do not have work manager 202.

In the illustrative example, the use of work manager 202 in computer system 222 integrates processes into a practical application for managing manufacturing of object 204 that enables computer system 222 to display visualizations of work orders 228 and information about minimum safety distances in a graphical user interface. In this manner, computer system 222 with work manager 202 provides graphical user interface 306 that is a visualization tool for human operator 310 to manage work orders 228 for assembling object 204. In yet other illustrative examples, work manager 202 can automatically schedule or reschedule work orders 228 based on minimum safety distances 230 in a manner that can be used by manufacturing facility 214.

In one illustrative example, computer system 222 with work manager 202 identifies work orders 228 for object 204 that have work areas 234 with less than minimum safety distance 236 from each other. Computer system 222 with work manager 202 performs a set of actions 244 for work orders 228 to manage the manufacturing of object 204. In this manner, work manager 202 in computer system 222 provides a practical application for managing the manufacturing of object 204.

The illustrations of work order management environment 200 and the different components in work order management environment 200 in FIG. 2 and FIG. 3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, object 204 can take a number of different forms in addition to or in place of aircraft 208. For example, object 204 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical take-off and landing aircraft, a surface ship, a tank, a personnel carrier, a train, a spacecraft, a space station, a satellite, a submarine, an automobile, a power plant, a bridge, a dam, a house, a manufacturing facility, a building, a fuselage section, an engine housing, a fuel tank, and a wing.

In another illustrative example, work orders 228 can include partially-scheduled work orders in addition to scheduled work orders 238 and unscheduled work orders 240. A partially-scheduled work order may be assigned a time but not a human operator or a group of human operators to work on the work order. In another example, a partially-scheduled work order may be assigned a human operator but not a time for performing the work order. In this illustrative example, work manager 202 can schedule or reschedule work orders 238 based on information available in partially-scheduled work orders.

For example, work manager 202 can identify work orders 228 that are performed by the same human operator. In this case, minimum safety distance 236 is not required between work orders 238 being performed by the same human operator.

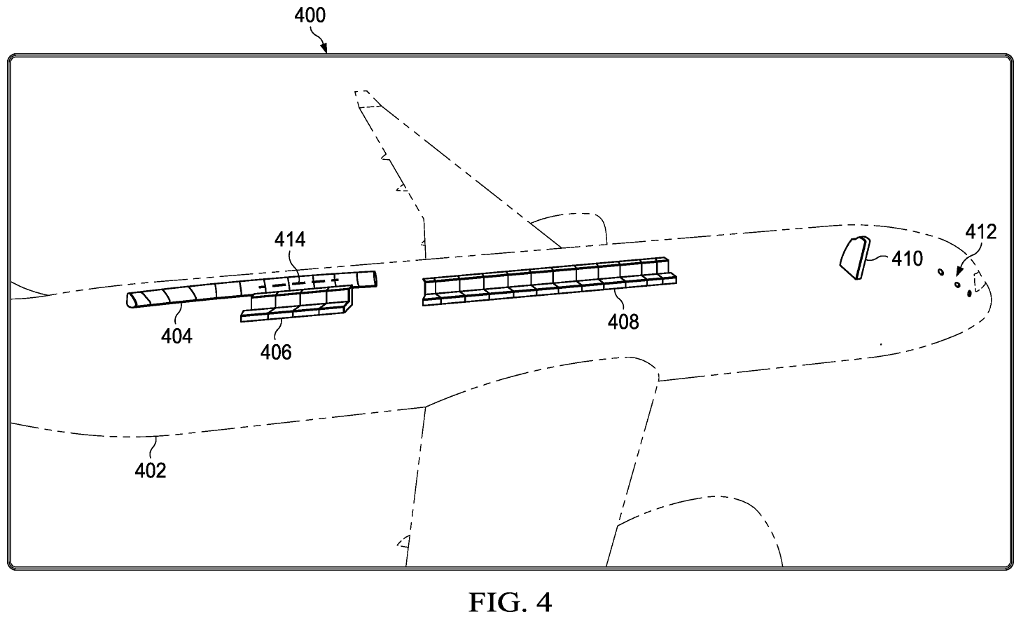

Turning to FIG. 4, an illustration of a display of parts for work orders in a graphical user interface is depicted in accordance with an illustrative embodiment. In this illustrative example, display 400 is an example of a display that can be displayed in graphical user interface 306 on display system 308 in FIG. 3.

In this example, a portion of aircraft 402 is seen in a three-dimensional view in display 400. In this illustrative example, parts for work orders are displayed in display 400. In this example, parts 404, parts 406, parts 408, parts 410, and parts 412 are displayed for five work orders. These parts are displayed in installation locations and in an as assembled form. These work orders are selected as work orders of interest for analysis in this example.

In this illustrative example, line 414 is a graphical indicator displayed to indicate that a minimum safety distance is not present in the work areas for installing parts 404 and parts 406. In this illustrative example, graphical indicators for work areas are not shown. The graphical indicators for the work areas can be shown in other illustrative examples.

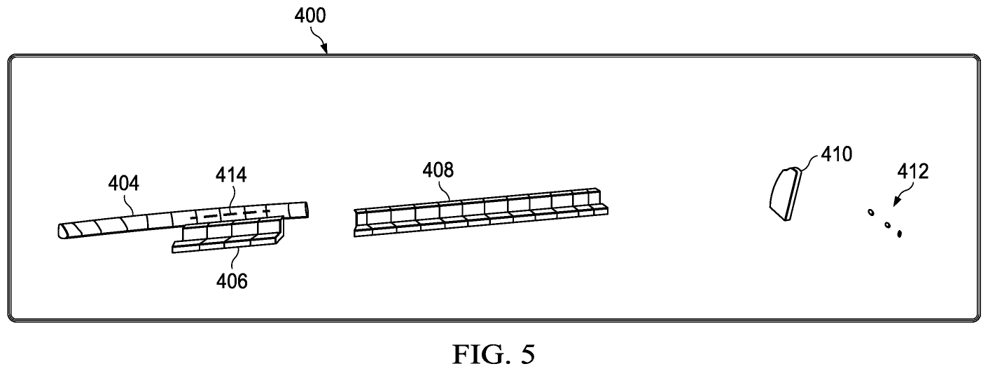

With reference to FIG. 5, another illustration of a display of parts for work orders in a graphical user interface is depicted in accordance with an illustrative embodiment. In this figure, the context of portion of aircraft 402 in FIG. 4 has been removed in display 400. As depicted, parts 404, parts 406, parts 408, parts 410, and parts 412 for five work orders are displayed in installation locations without the context of other portions of aircraft 402.

Turning next to FIG. 6, yet another illustration of a display of parts for work orders in a graphical user interface is depicted in accordance with an illustrative embodiment. In this illustrative example, display 600 is an example of a display that can be displayed in graphical user interface 306 on display system 308 in FIG. 3.

In this illustrative example, parts 602 and parts 604 are shown in a three-dimensional view on display 600 in installation locations. Additionally, graphical indicator 606 identifies a work area for installing parts 602. Graphical indicator 608 identifies a work area for installing parts 604. These graphical indicators identify models for the work areas to install parts 602 and parts 604.

As depicted in this figure, graphical indicator 610 indicates the distance between the work areas. In this illustrative example, the distance indicated by graphical indicator 610 is 15 feet. This indication means more than a minimum safety distance is present for human operators to install parts 602 and parts 604 during time periods that overlap.

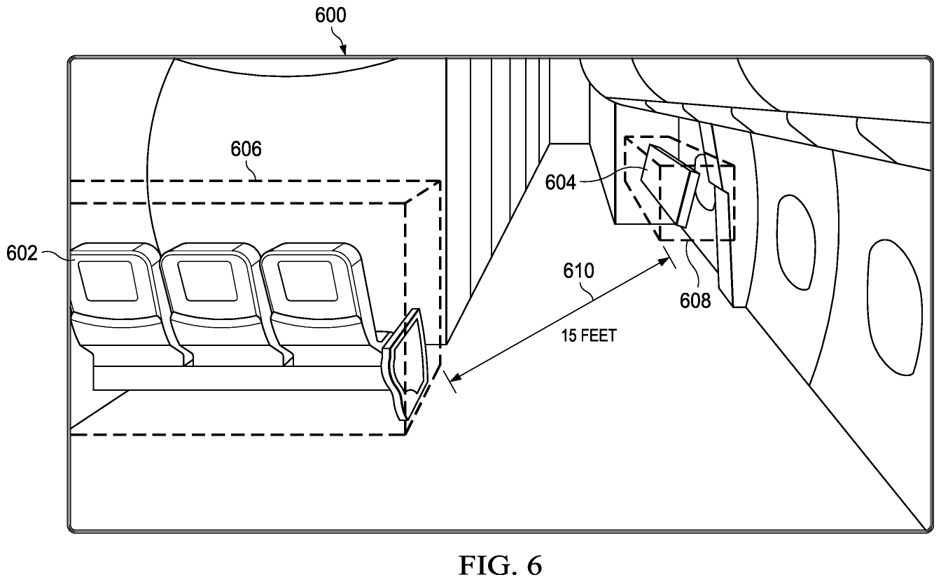

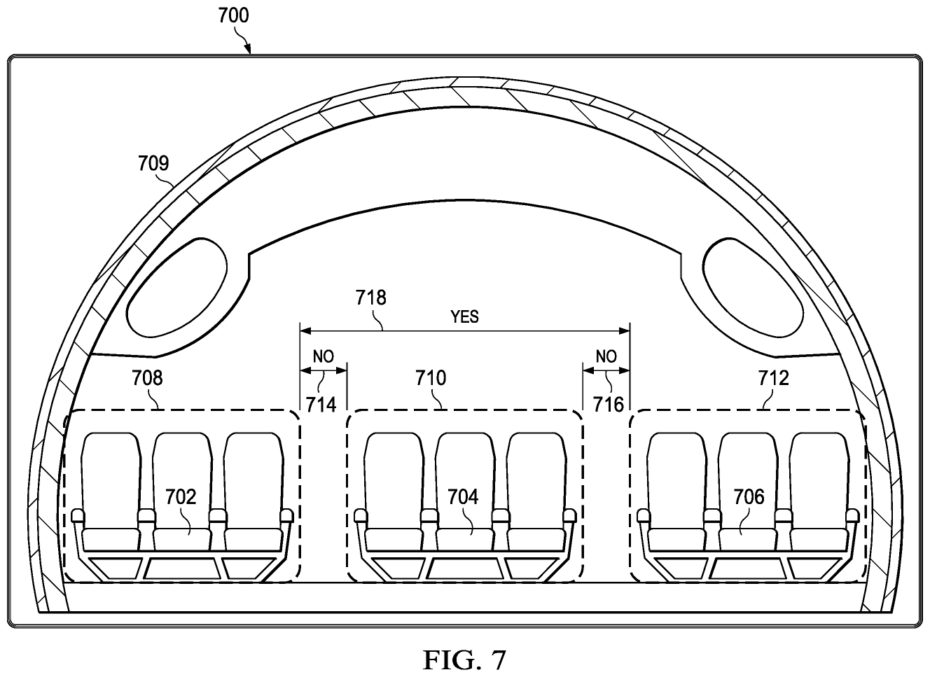

Turning next to FIG. 7, still another illustration of a display of parts for work orders in a graphical user interface is depicted in accordance with an illustrative embodiment. In this illustrative example, display 700 is an example of a display that can be displayed in graphical user interface 306 on display system 308 in FIG. 3.

In this example, display 700 is a two-dimensional view of parts 702, parts 704, and parts 706 that are to be installed in aircraft 709. These three groups of parts are installed using three work orders.

In this illustrative example, graphical indicator 708 indicates the work area for parts 702; graphical indicator 710 indicates the work area for parts 704; and graphical indicator 712 indicates the work area for parts 706.

In this illustrative example, graphical indicator 714 is a line with a “No” that indicates that the minimum safety distance is not present between the work area for installing parts 702 and the work area for installing parts 704. Further, graphical indicator 716 is a line with a “No” that indicates that the minimum safety distance is not present between the work area for installing parts 704 and the work area for installing parts 706. As depicted in display 700, graphical indicator 718 is a line with a “Yes” that indicates that the minimum safety distance is present between the work area for installing parts 702 and the work area for installing parts 706.

The illustration of displays in FIGS. 4-7 are presented for purposes of illustrating some non-limiting implementations for visualizations that can be displayed in a graphical user interface such as graphical user interface 306 in display system 308 in human machine interface 316 in FIG. 3. These displays are only intended to show some implementations and are not meant to limit the manner in which visualizations can be displayed in graphical user interface 306 in other illustrative examples. For example, instead of using a “Yes” or “No” as a graphical indicator to indicate whether a minimum safety distance is present between work areas, a color can be used. For example, a green line can indicate that the minimum safety distance is present, while a red line indicates that the minimum safety distance is not present.

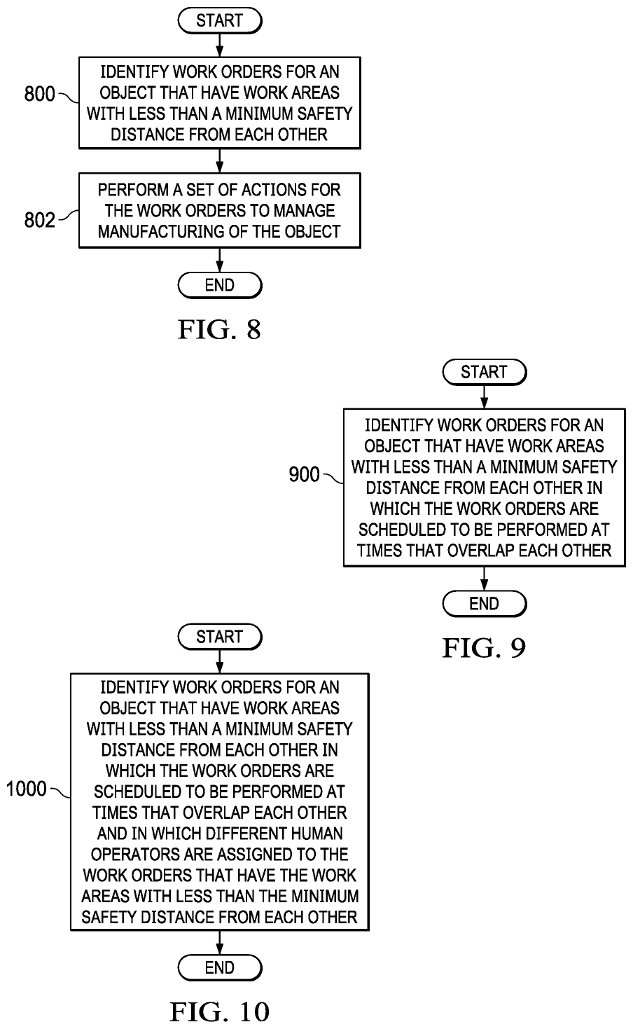

Turning next to FIG. 8, an illustration of a flowchart of a process for managing a manufacturing of an object is depicted in accordance with an illustrative embodiment. The process in FIG. 8 can be implemented in hardware, software, or both. When implemented in software, the process can take the form of program code that is run by one or more processor units located in one or more hardware devices in one or more computer systems. For example, the process can be implemented in work manager 202 in computer system 222 in FIG. 2.

The process begins by identifying work orders for an object that have work areas with less than a minimum safety distance from each other (operation 800). The process performs a set of actions for the work orders to manage manufacturing of the object (operation 802). The process terminates thereafter.

With reference to FIG. 9, an illustration of a flowchart of a process for identifying work orders is depicted in accordance with an illustrative embodiment. The process illustrated in FIG. 9 is an example of one implementation for operation 800 in FIG. 8.

The process identifies work orders for an object that have work areas with less than a minimum safety distance from each other in which the work orders are scheduled to be performed at times that overlap each other (operation 900). The process terminates thereafter.

In operation 900, issues with the minimum safety distance for already scheduled work orders can be determined. This identification can be performed for use in an action to determine whether the work orders should be rescheduled.

Turning to FIG. 10, an illustration of a flowchart of a process for identifying work orders is depicted in accordance with an illustrative embodiment. The process illustrated in FIG. 9 is an example of one implementation for operation 800 in FIG. 8. This process can be used with work orders that have already been assigned to human operators.

The process identifies work orders for an object that have work areas with less than a minimum safety distance from each other in which the work orders are scheduled to be performed at times that overlap each other and in which different human operators are assigned to the work orders that have the work areas with less than the minimum safety distance from each other (operation 1000). The process terminates thereafter.

Operation 1000 can be used to examine operations that have already been assigned for performance to particular human operators. The process identifies work orders to be performed at times that overlap each other with work areas that do not have the minimum safety distance and are assigned to different human operators. In this manner, work orders with the same human operator that do not have the minimum safety distance do not have to be reassigned.

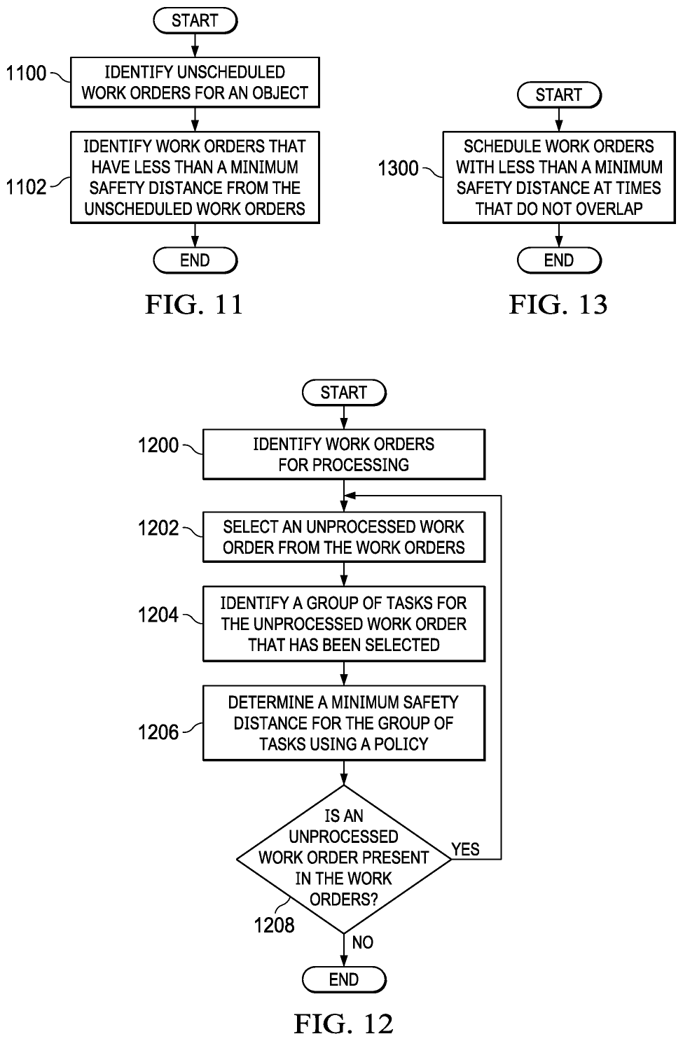

With reference to FIG. 11, an illustration of a flowchart of a process for identifying work orders is depicted in accordance with an illustrative embodiment. The process illustrated in FIG. 11 is an example of one implementation for operation 800 in FIG. 8.

The process identifies unscheduled work orders for an object (operation 1100). The process identifies work orders that have less than a minimum safety distance from the unscheduled work orders (operation 1102). In operation 1102, the work areas between the unscheduled work orders identified in operation 1100 can be compared to any remaining work orders regardless of whether those remaining work orders have been scheduled. The process terminates thereafter. This identification can be performed for use in an action such as determining how to schedule work orders that have not yet been scheduled.

In FIG. 12, an illustration of a flowchart of a process for identifying a minimum safety distance for a work order is depicted in accordance with an illustrative embodiment. The operations in FIG. 12 are an example of additional operations that can be performed as part of the process illustrated in the flowchart in FIG. 8.

The process begins by identifying work orders for processing (operation 1200). The process selects an unprocessed work order from the work orders (operation 1202).

The process identifies a group of tasks for the unprocessed work order that has been selected (operation 1204). The process determines a minimum safety distance for the group of tasks using a policy (operation 1206). In operation 1206, the minimum safety distance can be determined by applying the policy to the tasks being performed.

For example, the policy can be a health safety rule that requires a minimum distance of six feet between human operators for social distancing when performing tasks without personal protective equipment. If the group of tasks for the work order is performed using a respirator, such as, when applying paint, the minimum distance to another work area may be less than six feet. As another example, if a structure such as a wall is present on one side of a work area, the minimum safety distance for that side of the work area may be less than six feet while other sides of the work area are maintained at six feet.

In another example, the minimum safety distance may be based on a stay-out zone. In this case, the minimum safety distance is the distance from the work area to the perimeter of the stay-out zone. For example, if the perimeter of the stay-out zone extends three feet from the work area in which the tasks are to be performed, the minimum safety distance can be three feet with respect to the work area for another work order.

A determination is made as to whether an unprocessed work order is present in the work orders (operation 1208). If an unprocessed work order is present, the process returns to operation 1202. Otherwise, the process terminates.

With reference to FIG. 13, an illustration of a flowchart of a process for managing a manufacturing of an object is depicted in accordance with an illustrative embodiment. The operation in FIG. 13 is an example of an implementation for operation 802 in FIG. 8.

The process begins by scheduling work orders with less than a minimum safety distance at times that do not overlap (operation 1300). The process terminates thereafter.

In operation 1300, the process can reschedule work orders that have already been scheduled to have times that do not overlap. Operation 1300 can also be applied to unscheduled work orders such that the scheduling occurs such that the work orders are performed at times that do not overlap. Operation 1300 can be applied to both scheduled and unscheduled work orders such that work orders with work areas that have less than a minimum safety distance from each other are scheduled such that the times during which the work orders are to be performed do not overlap.

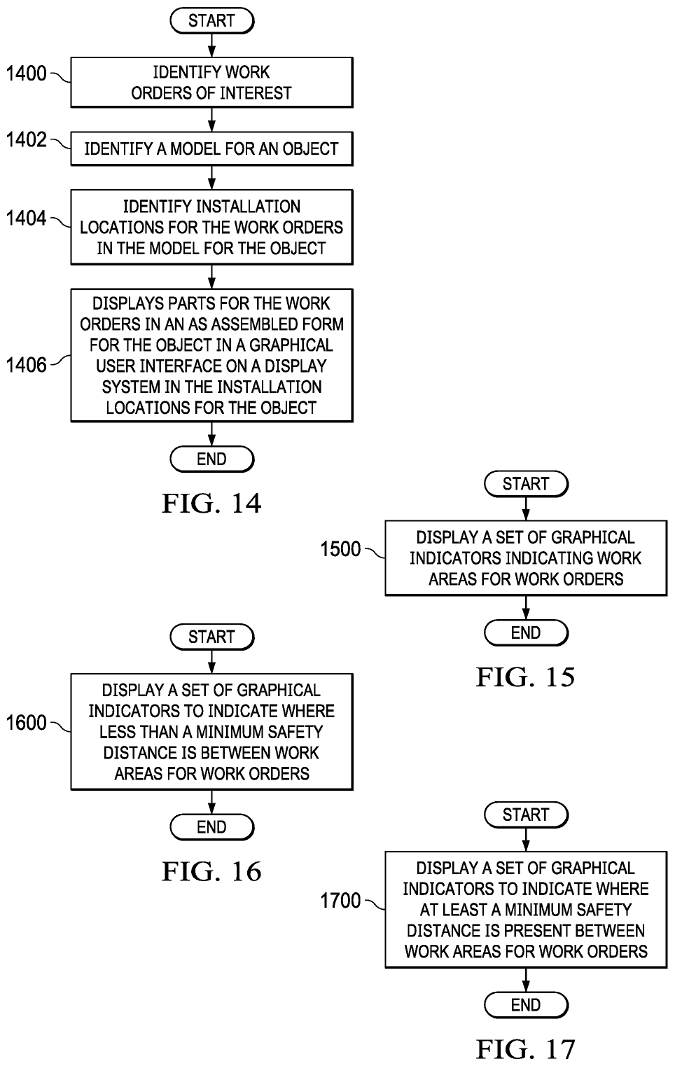

The process illustrated in FIGS. 14-17 are examples of operations that can be performed when work manager 202 in computer system 222 in FIG. 2 performs a set of actions. Turning first to FIG. 14, an illustration of a flowchart of a process for visualizing work orders for manufacturing an object is depicted in accordance with an illustrative embodiment. The process in FIG. 14 can be implemented in hardware, software, or both. When implemented in software, the process can take the form of program code that is run by one or more processor units located in one or more hardware devices in one or more computer systems. For example, the process can be implemented in work manager 202 in computer system 222 in FIG. 2.

The process begins by identifying work orders of interest (operation 1400). In operation 1400, the work orders that have been identified as work orders of interest can be all of the work orders, work orders that have minimum safety distances, work orders that do not have minimum safety distances, or some combination thereof.

The process identifies a model for an object (operation 1402). The process identifies installation locations for the work orders in the model for the object (operation 1404).

The process displays parts for the work orders in an as assembled form for the object in a graphical user interface on a display system in installation the locations for the object (operation 1406). The process terminates thereafter.

In this example, the display of the parts in the as assembled form can be a display of sections of the object containing the parts. Display of the sections of the aircraft may be useful for performance purposes when the model is for an object such as an aircraft. As a result, sections of the aircraft can be displayed rather than displaying the entire model of the aircraft. The sections are sections containing installation locations for the work orders.

With reference next to FIG. 15, an illustration of a flowchart of an operation for visualizing work orders for manufacturing an object is depicted in accordance with an illustrative embodiment. The process in FIG. 15 includes additional operations that can be performed in the process in FIG. 14.

The process displays a set of graphical indicators indicating work areas for work orders (operation 1500). The process terminates thereafter.

With reference to FIG. 16, another illustration of a flowchart of an operation for visualizing work orders for manufacturing an object is depicted in accordance with an illustrative embodiment. The process in FIG. 16 includes additional operations that can be performed in the process in FIG. 14.

The process displays a set of graphical indicators to indicate where less than a minimum safety distance is between work areas for work orders (operation 1600). The process terminates thereafter.

Turning now to FIG. 17, yet another illustration of a flowchart of an operation for visualizing work orders for manufacturing an object is depicted in accordance with an illustrative embodiment. The process in FIG. 17 includes additional operations that can be performed in the process in FIG. 14.

The process displays a set of graphical indicators to indicate where at least a minimum safety distance is present between work areas for work orders (operation 1700). The process terminates thereafter. In operation 1700, “at least a minimum safety distance” means that the minimum safety distance or a greater distance than the minimum safety distance is present between the work areas for the work orders.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, in the flowchart in FIG. 13, scheduling of work orders can be performed such that the same human operator performs the work orders that do not have the minimum safety distance when possible.

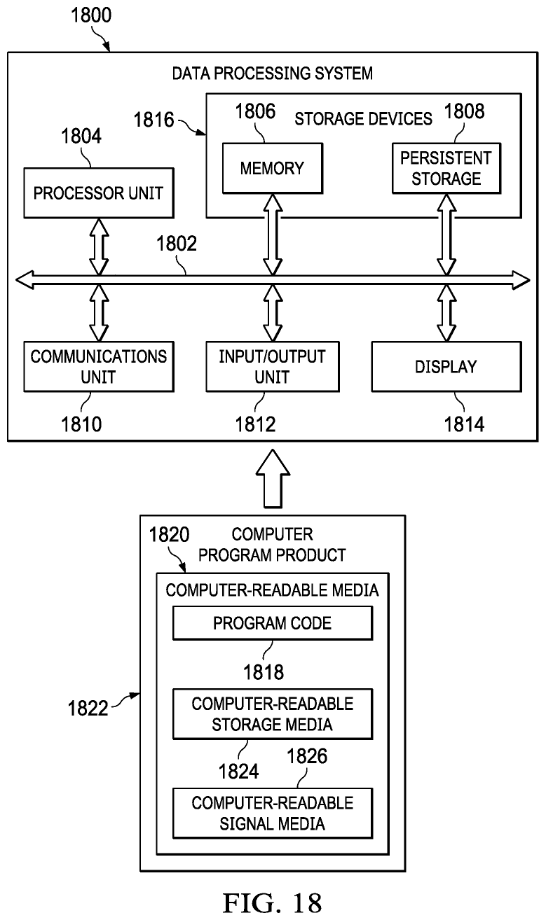

Turning now to FIG. 18, an illustration of a block diagram of a data processing system is depicted in accordance with an illustrative embodiment. Data processing system 1800 can be used to implement server computer 104, server computer 106, and client devices 110 in FIG. 1. Data processing system 1800 can also be used to implement computer system 222 in FIG. 2. In this illustrative example, data processing system 1800 includes communications framework 1802, which provides communications between processor unit 1804, memory 1806, persistent storage 1808, communications unit 1810, input/output (I/O) unit 1812, and display 1814. In this example, communications framework 1802 takes the form of a bus system.

Processor unit 1804 serves to execute instructions for software that can be loaded into memory 1806. Processor unit 1804 includes one or more processors. For example, processor unit 1804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1804 can may be implemented using one or more heterogeneous processor systems in which a main processor is present with secondary processors on a single chip. As another illustrative example, processor unit 1804 can be a symmetric multi-processor system containing multiple processors of the same type on a single chip.

Memory 1806 and persistent storage 1808 are examples of storage devices 1816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1816 may also be referred to as computer-readable storage devices in these illustrative examples. Memory 1806, in these examples, can be, for example, a random-access memory or any other suitable volatile or non-volatile storage device. Persistent storage 1808 can take various forms, depending on the particular implementation.

For example, persistent storage 1808 may contain one or more components or devices. For example, persistent storage 1808 can be a hard drive, a solid-state drive (SSD), a flash memory, a rewritable optical disk, a rewritable magnetic tape, or some combination of the above. The media used by persistent storage 1808 also can be removable. For example, a removable hard drive can be used for persistent storage 1808.

Communications unit 1810, in these illustrative examples, provides for communications with other data processing systems or devices. In these illustrative examples, communications unit 1810 is a network interface card.

Input/output unit 1812 allows for input and output of data with other devices that can be connected to data processing system 1800. For example, input/output unit 1812 can provide a connection for user input through at least one of a keyboard, a mouse, or some other suitable input device. Further, input/output unit 1812 can send output to a printer. Display 1814 provides a mechanism to display information to a user.

Instructions for at least one of the operating system, applications, or programs can be located in storage devices 1816, which are in communication with processor unit 1804 through communications framework 1802. The processes of the different embodiments can be performed by processor unit 1804 using computer-implemented instructions, which can be located in a memory, such as memory 1806.

These instructions are referred to as program code, computer usable program code, or computer-readable program code that can be read and executed by a processor in processor unit 1804. The program code in the different embodiments can be embodied on different physical or computer-readable storage media, such as memory 1806 or persistent storage 1808.

Program code 1818 is located in a functional form on computer-readable media 1820 that is selectively removable and can be loaded onto or transferred to data processing system 1800 for execution by processor unit 1804. Program code 1818 and computer-readable media 1820 form computer program product 1822 in these illustrative examples. In the illustrative example, computer-readable media 1820 is computer-readable storage media 1824.

In these illustrative examples, computer-readable storage media 1824 is a physical or tangible storage device used to store program code 1818 rather than a media that propagates or transmits program code 1818. Computer-readable storage media 1824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1818 can be transferred to data processing system 1800 using a computer-readable signal media. The computer-readable signal media can be, for example, a propagated data signal containing program code 1818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1820” can be singular or plural. For example, program code 1818 can be located in computer-readable media 1820 in the form of a single storage device or system. In another example, program code 1818 can be located in computer-readable media 1820 that is distributed in multiple data processing systems. In other words, some instructions in program code 1818 can be located in one data processing system while other instructions in program code 1818 can be located in one data processing system. For example, a portion of program code 1818 can be located in computer-readable media 1820 in a server computer while another portion of program code 1818 can be located in computer-readable media 1820 located in a set of client computers.

The different components illustrated for data processing system 1800 are not meant to provide architectural limitations to the manner in which different embodiments can be implemented. In some illustrative examples, one or more of the components may be incorporated in or otherwise form a portion of, another component. For example, memory 1806, or portions thereof, can be incorporated in processor unit 1804 in some illustrative examples. The different illustrative embodiments can be implemented in a data processing system including components in addition to or in place of those illustrated for data processing system 1800. Other components shown in FIG. 18 can be varied from the illustrative examples shown. The different embodiments can be implemented using any hardware device or system capable of running program code 1818.

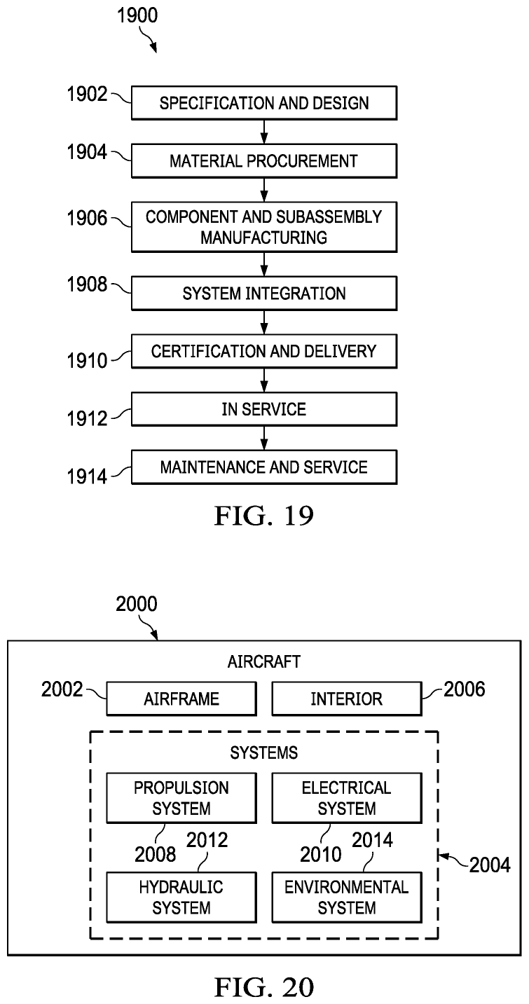

Illustrative embodiments of the disclosure may be described in the context of aircraft manufacturing and service method 1900 as shown in FIG. 19 and aircraft 2000 as shown in FIG. 20. Turning first to FIG. 19, an illustration of an aircraft manufacturing and service method is depicted in accordance with an illustrative embodiment. During pre-production, aircraft manufacturing and service method 1900 may include specification and design 1902 of aircraft 2000 in FIG. 20 and material procurement 1904.

During production, component and subassembly manufacturing 1906 and system integration 1908 of aircraft 2000 in FIG. 20 takes place. Thereafter, aircraft 2000 in FIG. 20 can go through certification and delivery 1910 in order to be placed in service 1912. While in service 1912 by a customer, aircraft 2000 in FIG. 20 is scheduled for routine maintenance and service 1914, which may include modification, reconfiguration, refurbishment, and other maintenance or service.

Each of the processes of aircraft manufacturing and service method 1900 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 20, an illustration of an aircraft is depicted in which an illustrative embodiment may be implemented. In this example, aircraft 2000 is produced by aircraft manufacturing and service method 1900 in FIG. 19 and may include airframe 2002 with plurality of systems 2004 and interior 2006. Examples of systems 2004 include one or more of propulsion system 2008, electrical system 2010, hydraulic system 2012, and environmental system 2014. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1900 in FIG. 19.

In one illustrative example, components or subassemblies produced in component and subassembly manufacturing 1906 in FIG. 19 can be fabricated or manufactured in a manner similar to components or subassemblies produced while aircraft 2000 is in service 1912 in FIG. 19. As yet another example, one or more apparatus embodiments, method embodiments, or a combination thereof can be utilized during production stages, such as component and subassembly manufacturing 1906 and system integration 1908 in FIG. 19. One or more apparatus embodiments, method embodiments, or a combination thereof may be utilized while aircraft 2000 is in service 1912, during maintenance and service 1914 in FIG. 19, or both. The use of a number of the different illustrative embodiments may substantially expedite the assembly of aircraft 2000, reduce the cost of aircraft 2000, or both expedite the assembly of aircraft 2000 and reduce the cost of aircraft 2000.

For example, work manager 202 in FIG. 2 can be used to manage a schedule of work orders for manufacturing aircraft 2000. At least one of analyzing or scheduling work orders can be performed during at least one of system integration 1908 or routine maintenance and service 1914. The use of work manager 202 can reduce the time and expense needed to perform tasks for work orders in a manner that takes into account minimum safety distances that may be needed for performing different tasks to manufacture aircraft 2000.

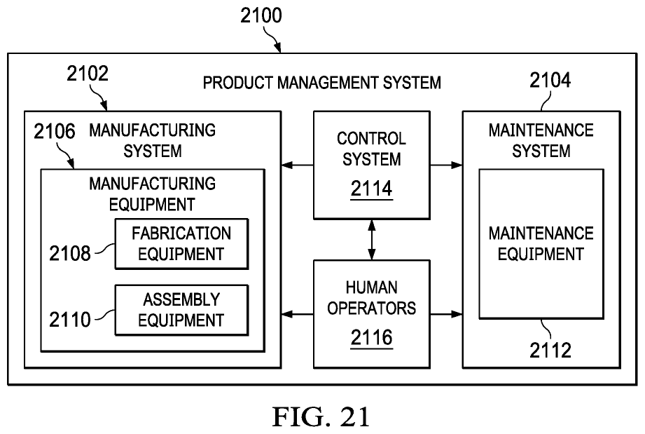

Turning now to FIG. 21, an illustration of a block diagram of a product management system is depicted in accordance with an illustrative embodiment. Product management system 2100 is a physical hardware system. In this illustrative example, product management system 2100 includes at least one of manufacturing system 2102 or maintenance system 2104.

Manufacturing system 2102 is configured to manufacture products, such as aircraft 2000 in FIG. 20. As depicted, manufacturing system 2102 includes manufacturing equipment 2106. Manufacturing equipment 2106 includes at least one of fabrication equipment 2108 or assembly equipment 2110.

Fabrication equipment 2108 is equipment that used to fabricate components for parts used to form aircraft 2000 in FIG. 20. For example, fabrication equipment 2108 can include machines and tools. These machines and tools can be at least one of a drill, a hydraulic press, a furnace, a mold, a composite tape laying machine, a vacuum system, a lathe, or other suitable types of equipment. Fabrication equipment 2108 can be used to fabricate at least one of metal parts, composite parts, semiconductors, circuits, fasteners, ribs, skin panels, spars, antennas, or other suitable types of parts.

Assembly equipment 2110 is equipment used to assemble parts to form aircraft 2000 in FIG. 20. In particular, assembly equipment 2110 is used to assemble components and parts to form aircraft 2000 in FIG. 20. Assembly equipment 2110 also can include machines and tools. These machines and tools may be at least one of a robotic arm, a crawler, a fastener installation system, a rail-based drilling system, or a robot. Assembly equipment 2110 can be used to assemble parts such as seats, horizontal stabilizers, wings, engines, engine housings, landing gear systems, and other parts for aircraft 2000 in FIG. 20.

In this illustrative example, maintenance system 2104 includes maintenance equipment 2112. Maintenance equipment 2112 can include any equipment needed to perform maintenance on aircraft 2000 in FIG. 20. Maintenance equipment 2112 may include tools for performing different operations on parts on aircraft 2000 in FIG. 20. These operations can include at least one of disassembling parts, refurbishing parts, inspecting parts, reworking parts, manufacturing replacement parts, or other operations for performing maintenance on aircraft 2000 in FIG. 20. These operations can be for routine maintenance, inspections, upgrades, refurbishment, or other types of maintenance operations.

In the illustrative example, maintenance equipment 2112 may include ultrasonic inspection devices, x-ray imaging systems, vision systems, drills, crawlers, and other suitable devices. In some cases, maintenance equipment 2112 can include fabrication equipment 2108, assembly equipment 2110, or both to produce and assemble parts that needed for maintenance.

Product management system 2100 also includes control system 2114. Control system 2114 is a hardware system and may also include software or other types of components. Control system 2114 is configured to control the operation of at least one of manufacturing system 2102 or maintenance system 2104. In particular, control system 2114 can control the operation of at least one of fabrication equipment 2108, assembly equipment 2110, or maintenance equipment 2112.

The hardware in control system 2114 can be implemented using hardware that may include computers, circuits, networks, and other types of equipment. The control may take the form of direct control of manufacturing equipment 2106. For example, robots, computer-controlled machines, and other equipment can be controlled by control system 2114. In other illustrative examples, control system 2114 can manage operations performed by human operators 2116 in manufacturing or performing maintenance on aircraft 2000. For example, control system 2114 can assign tasks, provide instructions, display models, or perform other operations to manage operations performed by human operators 2116. In these illustrative examples, work manager 202 can be implemented in control system 2114 or can communicate with control system 2114 to manage at least one of the manufacturing or maintenance of aircraft 2000 in FIG. 20. For example, work manager 202 in FIG. 2 can generate a schedule for work orders 228. These work orders can then be sent to or communicated with human operators 2116 to instruct human operators 2116 to perform tasks to assemble a product such as object 204 or aircraft 208 in FIG. 2.

In the different illustrative examples, human operators 2116 can operate or interact with at least one of manufacturing equipment 2106, maintenance equipment 2112, or control system 2114. This interaction can occur to manufacture aircraft 2000 in FIG. 20.

Of course, product management system 2100 may be configured to manage other products other than aircraft 2000 in FIG. 20. Although product management system 2100 has been described with respect to manufacturing in the aerospace industry, product management system 2100 can be configured to manage products for other industries. For example, product management system 2100 can be configured to manufacture products for the automotive industry as well as any other suitable industries.

Thus, the illustrative embodiments provide a method, apparatus, system, and computer program product for managing a manufacturing of an object. Work orders for the object that have work areas with less than a minimum safety distance from each other are identified by a computer system. A set of actions is performed by the computer system for the work orders to manage the manufacturing of the object.

Thus, the illustrative example enables scheduling work orders for tasks to assemble an object, such as an aircraft, in a manner that takes into account a safety policy such as social distancing. In an illustrative example, a visualization can be provided on a graphical user interface to allow a human operator to visualize where tasks are to be performed for installing parts for work orders. This visualization enables the human operator to see whether a minimum safety distance is present between work areas for the work orders. Graphical indicators can be displayed to indicate whether minimum safety distances are present.

In addition, an illustrative example enables a work manager to schedule work orders in a manner that maintains a minimum safety distance between work areas. For example, the work orders can be scheduled to be performed at times that do not overlap if the areas with work orders would not support a minimum safety distance when the work orders are performed at the same time or at times that overlap. As a result, the assembly of an object, such as an aircraft, can be performed in a manner that complies with safety rules.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A work management system comprising:
a computer system; and
a work manager in the computer system, wherein the work manager is configured to:
identify work orders for an aircraft that have work areas with less than a minimum safety distance from each other in which the work orders are scheduled to be performed at times that overlap each other; and
perform a set of actions for the work orders.

2. The work management system of claim 1, wherein in performing set of actions for the work orders, the work manager is configured to:
display parts in the work orders in an as assembled form in the aircraft in a graphical user interface on a display system in installation locations for the aircraft.

3. The work management system of claim 2, wherein in performing the set of actions for the work orders, the work manager is configured to:
display a set of graphical indicators that indicate the work areas for the work orders.

4. The work management system of claim 2, wherein in performing the set of actions for the work orders, the work manager is configured to:
display a set of graphical indicators that indicates where less than the minimum safety distance is present between the work areas for the work orders.

5. The work management system of claim 2, wherein in performing the set of actions for the work orders, the work manager is configured to:
display a set of graphical indicators that indicate where at least the minimum safety distance is present between the work areas for the work orders.

6. The work management system of claim 2, wherein in performing the set of actions for the work orders, the work manager is configured to:
manage scheduling of the work orders based on the minimum safety distance.

7. The work management system of claim 1, wherein the minimum safety distance is based on at least one of a social distancing policy, a health safety policy, flammability, a stay-out zone, or a welding safety distance.

8. A work management system comprising:
a computer system; and
a work manager in the computer system, wherein the work manager is configured to:
identify work orders for an object that have work areas with less than a minimum safety distance from each other; and
perform a set of actions for the work orders.

9. The work management system of claim 8, wherein in identifying the work orders for the object that have the work areas with less than the minimum safety distance from each other in which the work orders, the work manager is configured to:
identify the work orders for the object that have the work areas with less than the minimum safety distance from each other in which the work orders are scheduled to be performed at times that overlap each other.

10. The work management system of claim 8, wherein in performing the set of actions for the work orders, the work manager is configured to:
display parts in the work orders in an as assembled form in the object in a graphical user interface on a display system in installation locations for the object.

11. The work management system of claim 10, wherein in performing the set of actions for the work orders, the work manager is configured to:
display a set of graphical indicators that indicates the work areas for the work orders.

12. The work management system of claim 10, wherein in performing the set of actions for the work orders, the work manager is configured to:
display a set of graphical indicators that indicates where less than the minimum safety distance is present between the work areas for the work orders.

13. The work management system of claim 10, wherein in performing the set of actions for the work orders, the work manager is configured to:
display a set of graphical indicators that indicates where at least the minimum safety distance is present between the work areas for the work orders.

14. The work management system of claim 10, wherein in performing the set of actions for the work orders, the work manager is configured to:
manage scheduling of the work orders based on minimum safety distances.

15. The work management system of claim 8, wherein the minimum safety distance is based on at least one of a social distancing policy, a health safety policy, flammability, a stay-out zone, or a welding safety distance.

16. The work management system of claim 8, wherein the object is selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical take-off and landing aircraft, a surface ship, a tank, a personnel carrier, a train, a spacecraft, a space station, a satellite, a submarine, an automobile, a power plant, a bridge, a dam, a house, a manufacturing facility, a building, a fuselage section, an engine housing, a fuel tank, and a wing.

17. A method for managing a manufacturing of an object, the method comprising:
identifying, by a computer system, work orders for the object that have work areas with less than a minimum safety distance from each other; and
performing, by the computer system, a set of actions for the work orders to manage the manufacturing of the object.

18. The method of claim 17, wherein identifying, by the computer system, the work orders for the object that have the work areas with less than the minimum safety distance from each other in which the work orders comprises:
identifying, by the computer system, the work orders for the object that have the work areas with less than the minimum safety distance from each other in which the work orders are scheduled to be performed at times that overlap each other.

19. The method of claim 17, wherein identifying, by the computer system, the work orders for the object that have the work areas with less than the minimum safety distance from each other in which the work orders comprises:
identifying, by the computer system, the work orders for the object that have the work areas with less than the minimum safety distance from each other in which the work orders are scheduled to be performed at times that overlap each other and in which different human operators are assigned to the work orders that have the work areas with less than the minimum safety distance from each other.

20. The method of claim 17, wherein performing, by the computer system, the set of actions for the work orders comprises:
displaying, by the computer system, parts in the work orders in an as assembled form for in the object in a graphical user interface on a display system in installation locations for the object.

21. The method of claim 20, wherein performing, by the computer system, the set of actions for the work orders further comprises:
displaying, by the computer system, a set of graphical indicators that indicates the work areas for the work orders.

22. The method of claim 20, wherein performing, by the computer system, the set of actions for the work orders further comprises:
displaying, by the computer system, a set of graphical indicators that indicates where less than the minimum safety distance is present between the work areas for the work orders.

23. The method of claim 20, wherein performing the set of actions for the work orders further comprises:
displaying, by the computer system, a set of graphical indicators that indicates where at least the minimum safety distance is present between the work areas for the work orders.

24. The method of claim 20, wherein performing the set of actions for the work orders comprises:
managing, by the computer system, scheduling of the work orders based on minimum safety distances.

25. The method of claim 17, wherein the minimum safety distance is based on at least one of a social distancing policy, a health safety policy, flammability, a stay-out zone, or a welding safety distance.

26. The method of claim 17, wherein the object is selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical take-off and landing aircraft, a surface ship, a tank, a personnel carrier, a train, a spacecraft, a space station, a satellite, a submarine, an automobile, a power plant, a bridge, a dam, a house, a manufacturing facility, a building, a fuselage section, an engine housing, a fuel tank, and a wing.

27. A computer program product for managing a manufacturing of an object, the computer program product comprising:
a computer-readable storage media;
first program code, stored on the computer-readable storage media, executable by a computer system to cause the computer system to identify work orders for the object that have work areas with less than a minimum safety distance from each other; and
second program code, stored on the computer-readable storage media, executable by the computer system to cause the computer system to perform a set of actions for the work orders to manage the manufacturing of the object.

28. The computer program product of claim 27, wherein the second program code comprises:
program code, stored on the computer-readable storage media, executable by the computer system to cause the computer system to identify the work orders for the object that have the work areas with less than the minimum safety distance from each other in which the work orders are scheduled to be performed at times that overlap each other.

29. The computer program product of claim 27, wherein the second program code comprises:
program code, stored on the computer-readable storage media, executable by the computer system to cause the computer system to display parts in the work orders in an as assembled form in a graphical user interface on a display system in installation locations for the object.
